(19) United States
(12) Patent Application Publication
(10) Pub. No.: US 2006/0008761 A1
(43) Pub. Date: Jan. 12, 2006

(54) Dental appliances having separate performance and bonding regions

(76) Inventor: Peter M. Allred, Riverton, UT (US)

Correspondence Address: John M. Guynn;WORKMAN, NYDEGGER & SEELEY, 1000 Eagle Gate Tower, 60 East South Temple, Salt Lake City, UT, 84111, US

(21) Appl. No.: 10/889,277

(22) Filed: Jul. 12, 2004

(51) Int. Cl. A61C 3/00

(52) U.S. Cl. 433/9; 433/10

(57) ABSTRACT

A dental appliance having a performance region and a separate bonding region. The dental appliance further includes a mounting surface configured to attach to a substrate, with at least a portion of the mounting surface being formed from the bonding region. The performance region imparts one or more desired performance properties (e.g., at least one of mechanical, handling, or aesthetic properties). The bonding region is selected to have a greater bonding strength to a bonding agent than the performance region. The bonding region may comprise one or more of a polymer, ceramic, or a metal oxide. In one embodiment, the bonding region can be one of polyamides, methacrylates, acrylates, and polycarbonates, or combinations thereof.

### BACKGROUND OF THE INVENTION

1. The Field of the Invention

The present invention relates to dental appliances. More particularly, the present invention is directed to dental appliances having separate performance and bonding regions formed from different materials in order to improve both the performance of the dental appliance and the bond strength to bonding agents.

2. The Relevant Technology

In the field of dentistry, it is common for dental appliances to be attached to a substrate. For example, orthodontics is a specialized field of dentistry that involves the use of various dental appliances that rely on mechanical forces to urge poorly positioned, or crooked, teeth into correct alignment and orientation. One example is the use of orthodontic brackets, commonly referred to as “braces”, which are used in combination with one or more arch wires. Orthodontic brackets are small slotted bodies configured for direct attachment to a patient's teeth. Once the brackets are affixed to the patient's teeth, such as by means of glue, a curved arch wire is inserted into the slot of each bracket. The arch wire acts as a template or track to guide movement of the teeth into proper alignment. Orthodontic brackets can be self-ligating or non-self-ligating. Self-ligating brackets do not require the use of ligatures (i.e., tie wires or elastic bands) to fasten the arch wire to the bracket.

Another orthodontic device is a bite ramp, which can be used to correct deep bite. Bite ramps typically include a performance region and a ramp element. The performance region is configured to be attached directly to a patient's tooth. The ramp element extends from the performance region and contacts the teeth on the opposing dental arch. Ramp elements can be rigidly or flexibly attached to the performance region.

Dentistry also uses other dental appliances that need to be securely attached to dental substrates. For example, crowns, bridges and veneers need to be tightly bonded to the tooth to prevent the dental appliance from becoming dislodged therefrom.

In view of the foregoing, it would be an improvement in the art to provide dental appliances that are able to readily bond to adhesives and bonding agents use to bond dental appliances to dental substrates (e.g., teeth) without sacrificing desired performance aspects.

### BRIEF SUMMARY OF THE INVENTION

The present invention is directed to dental appliances that include separate performance and bonding regions constructed using materials that may advantageously be selected to enhance both performance and bondability, respectively. The performance region advantageously comprises a material, or combination of materials, selected to enhance a desired performance property (e.g., strength, flexibility, bendability, durability, abrasion resistance, rigidity, other mechanical properties, color, shape, other aesthetic features, surface texture, smoothness, plaque resistance, and the like). The bonding region advantageously comprises a material, or combination of materials, selected to be compatible with bonding agents used to bond the dental appliance to a substrate (e.g., a tooth). The bonding region is not itself a bonding agent that bonds to a substrate independently of a separate bonding agent.

Examples of dental appliances according to the invention include, but are not limited to, orthodontic brackets, bite ramps, bands, crowns, bridges, and veneers. In a preferred embodiment, the material(s) comprising the bonding regions of such dental appliances will have substantially higher compatibility with bonding agents than the material(s) comprising the performance regions. Similarly, the material(s) within the performance region will preferably exhibit substantially better performance within the desired performance property than the material(s) within the bonding region.

Examples of materials that have been found to be especially compatible with bonding agents known in the art, and therefore suitable for use in making the bonding region, include, but are not limited to, less crystalline polyamides, methacrylates, acrylates, polycarbonates, metal oxides, ceramics, and combinations thereof. Examples of metal oxides that can be incorporated into the bonding region include, but are not limited to, alumina, silica, zirconia, and titanium dioxide. Examples of ceramics include metal oxides, metal carbides, and metal nitrides.

Examples of materials that have been found to exhibit desired properties within various performance properties include, but are not limited to, a wide variety of polymeric materials (including both thermoset and thermoplastic polymers), metals, metal alloys, ceramics, and combinations thereof. Examples of polymeric materials that can be included in the performance region include, but are not limited to, more crystalline polyamides, acetal polymers, urethanes, polyetherimides, polycarbonates, polysulphones, polyethersulphones, polyethylene terapthalate, polyethylene teraphthalate glycol, acrylics, polyarylether ketones, polyethylene, polypropylene, polyaramides, polyesters, polyarylamides, and combinations thereof. Examples of metals and metal alloys include, but are not limited to, stainless steel, stainless steel alloys, titanium, and nickel-titanium alloys. Examples of ceramics include metal oxides, metal carbides, and metal nitrides.

According to one embodiment, the performance and bonding regions may be constructed and situated such that only the bonding region forms a mounting surface that faces the substrate to which the dental appliance is to be bonded. In such cases, the bonding agent will primarily or solely contact the material(s) within the bonding region. According to another embodiment, the bonding region may only form part of the mounting surface facing the substrate to which the dental appliance is to be bonded.

The bonding region preferably comprises at least about 25% of the surface area of the mounting surface, more preferably at least about 50% of the mounting surface area, even more preferably at least about 75% of the mounting surface area, and most preferably at least about 90% of the mounting surface area. One of skill in the art may select the proportion of the mounting surface that comprises the bonding region in order to yield a dental appliance that has a desired balance between one or more desired performance properties and bondability to the bonding agent used to bond the dental appliance to a substrate.

In order to further improve the bond strength between the dental appliance and a substrate to which it is to be bonded, the mounting surface may include one or more of texture, undercuts, recesses, protrusions, or other mechanical features designed to enhance mechanical interlocking between the bonding agent and the mounting surface, in addition to the aforementioned chemical adhesion.

The materials used to form the performance and bonding regions can be formed and/or brought together using any desired process. For example, according to one embodiment, the materials used to form the performance and bonding regions can be co-molded and/or co-extruded together (e.g., using known 2-color molding processes). This process is especially suitable where two or more different polymeric materials or used to form different regions or segments of the dental appliance. In another embodiment, the performance and bonding regions can be formed separately and then joined together using known processes. In the case where a fired ceramic material and/or a molded or stamped metal is used in combination with a polymeric material, the ceramic material or metal will typically be formed or shaped in a separate process, followed by attachment of the polymeric material thereto.

According to one embodiment, the performance region of the dental appliance can be formed initially, followed by formation of the bonding region thereto, e.g., by overmolding, mechanical attachment, spraying, dipping, brushing, bonding, or a combination thereof. In the case where the bonding region comprises a polymeric material that is initially in a flowable state, the polymeric material is typically caused to solidify, e.g., by chemical, light or heat curing, cooling, and the like. This procedure may be used, for example, in the case where the performance region comprises a metal or ceramic that is formed using a high temperature molding or firing process and the bonding region comprises a polymeric material that would be destroyed during formation or molding of the ceramic or metal material. It may also be used in the case where a polymeric material used in the formation of the performance region is processed differently than a polymeric material used in the formation of the bonding region.

According to another embodiment, the bonding region can be formed initially, followed by formation of the performance region thereto, e.g., by overmolding or mechanical attachment. This procedure may be used, for example, in the case where the bonding region comprises a ceramic material and the performance region comprises a polymeric material or metal that would be destroyed or altered during formation of the ceramic material. It may also be used in the case where a polymeric material used in the formation of the bonding region is processed differently than a polymeric material used in the formation of the performance region.

The proportion or ratio between the performance region and bonding region can be selected to impart any desired balance between bondability, on the one hand, and desired performance properties, on the other. According to one embodiment, it may be desirable to minimize the size or proportion of the bonding region to only so much as may be needed to yield a dental appliance having a desired level of bondability to one or more bonding agents. In that way, the desired performance properties can be maximized while still providing a desired level of bondability. Consistent with this, it may be desirable to minimize the thickness of the bonding region and maximize the thickness of the performance region since only the surface of the bonding region chemically interacts with the bonding agent.

In general, the performance region preferably comprises at least about 25% by volume of the dental appliance, more preferably at least about 50% by volume of the dental appliance, even more preferably at least about 75% by volume of the dental appliance, and most preferably at least about 90% by volume of the dental appliance. Conversely, the bonding region preferably comprises up to about 75% by volume of the dental appliance, more preferably up to about 50% by volume of the dental appliance, even more preferably up to about 25% by volume of the dental appliance, and most preferably up to about 10% by volume of the dental appliance.

It should be understood that each of the performance and bonding regions may comprise a single material or region. Alternatively, one or both of the performance and bonding regions may comprise two or more different types of materials, either blended together and/or that comprise discrete subregions. Moreover, while the performance and bonding regions will generally comprise different materials overall, it is possible for the performance region to include two or more materials, with one or more of the materials being the same as or similar to one or more materials found in the bonding region. Similarly, it is possible for the bonding region to include two or more materials, with one or more of the materials being the same as or similar to one or more materials found in the performance region.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A shows a perspective view of an exemplary dental appliance according to one embodiment of the invention, illustrating the dental appliance in an open position;

FIG. 1B shows a perspective view of the dental appliance of FIG. 1A, illustrating the dental appliance in a closed position;

FIG. 2A shows a cross-sectional view of another embodiment of a dental appliance, illustrating the dental appliance in an open position;

FIG. 2B shows a cross-sectional view of the dental appliance of FIG. 2A, illustrating the dental appliance in a closed position;

FIG. 3A shows a cross-sectional view of another embodiment of a dental appliance, illustrating the dental appliance in an open position;

FIG. 3B shows a cross-sectional view of the dental appliance of FIG. 3A, illustrating the dental appliance in a closed position;

FIG. 4A shows a cross-sectional view of another embodiment of a dental appliance, illustrating the dental appliance in an open position;

FIG. 4B shows a cross-sectional view of the dental appliance of FIG. 4A, illustrating the dental appliance in a closed position;

FIG. 5A shows a cross-sectional view of another embodiment of a dental appliance, illustrating the dental appliance in an open position;

FIG. 5B shows a cross-sectional view of the dental appliance of FIG. 5A, illustrating the dental appliance in a closed position;

FIG. 6A shows a cross-sectional view of another embodiment of a dental appliance, illustrating the dental appliance in an open position;

FIG. 6B shows a cross-sectional view of the dental appliance of FIG. 6A, illustrating the dental appliance in a closed position;

FIG. 7A shows a cross-sectional view of another embodiment of a dental appliance, illustrating the dental appliance in an open position;

FIG. 7B shows a cross-sectional view of the dental appliance of FIG. 7A, illustrating the dental appliance in a closed position;

FIG. 8 shows a cross-sectional view of the dental appliance of FIG. 1 applied to a substrate (i.e., a tooth);

FIG. 9 shows a cross-sectional view of a conventional dental bracket applied to a substrate (i.e., a band);

FIG. 10 shows a perspective view of a dental band applied to a tooth; and

FIG. 11 shows a perspective view of a bite ramp applied to a tooth.

### DETAILED DESCRIPTION OF THE PREFERRED EMBODIMENTS

The present invention is related to dental appliances having a performance region associated with a bonding region so as to enhance both performance and bondability of the dental appliance, respectively. Generally, the bonding region is associated with the performance region so that the bonding region and/or the performance region forms a mounting surface for bonding to a bonding agent.

As used herein, the term “dental appliance” is used to broadly refer to various appliances in dentistry and orthodontics which are bonded at least indirectly to a person's tooth. Examples of dental appliances include, but are not limited to orthodontic brackets, bands, wires, bite ramps, veneers, crowns, and bridges.

As used herein, a “substrate” is the object to which the dental appliance is affixed. The substrate depends on the particular dental configuration. For example, in one configuration, an orthodontic bracket could be bonded directly to a person's tooth. In this case, the orthodontic bracket would be the “dental appliance” and the tooth is the “substrate.” In another configuration, an orthodontic bracket can be bonded to indirectly to a person's tooth by a band which is placed around the tooth. In this case, the bracket is the “dental appliance” and the band is the “substrate.” However, it is also possible that the band is the “dental appliance” and the tooth is the “substrate.” In other words, it can be important for both the bracket and the band to be tightly bonded to their respective substrates. Thus, the invention contemplates that both dental appliances (i.e., the bracket and the band) can include bonding regions, as will be discussed more fully below.

As used herein, the term “performance region” is broadly construed as the portion of the dental appliance which provides a desired performance property. Examples of performance property include, but are not limited to, strength, flexibility, bendability, durability, abrasion resistance, rigidity, other mechanical properties, color, shape, other aesthetic features, surface texture, smoothness, plaque resistance, and the like, or a combination thereof. Thus, the performance region can comprise a material which provides a particular performance property, or combination of performance properties. In one preferred embodiment, the performance region exhibits substantially better performance within the desired performance property than the material(s) within the bonding region.

As used herein, the term “bonding region” is broadly construed as the portion of the dental appliance that provides a greater bondability to a bonding agent than the performance region. That is, the material of the bonding region is more compatible with a bonding agent than the material of the performance region. Compatibility of the bonding region may be exhibited in higher chemical bond strength and/or mechanical bond strength with the bonding agent than the performance region. Thus, the bonding region is able to form a high-strength bond with a bonding agent applied to a substrate, ensuring that the dental appliance is tightly bonded to the substrate. The bonding region is not itself a bonding agent that bonds to a substrate independently of a separate bonding agent.

In each embodiment, the performance region of the dental appliance is associated with the bonding region. As used herein, the term “associated with” means that the bonding region is in some way joined to the performance region. The bonding region is essentially discrete from the performance region except for the interface therebetween where insignificant mixing may occur. Generally, the bonding region can be considered to form one or more discrete regions and/or layers with the performance region.

As used herein, the term “mounting surface” is a portion of the dental appliance that provides a minimum surface area which is sufficient to mount the dental appliance to a substrate. The mounting surface is generally located on one or more sides of the dental appliance. In one embodiment, the mounting surface can be composed of primarily the bonding region. In such cases, the bonding agent will primarily or solely contact the material(s) within the bonding region. In another embodiment, the bonding region may only form part of the mounting surface facing the substrate to which the dental appliance is to be bonded. That is, the bonding region and performance region may combine to form the mounting surface.

The bonding region preferably comprises at least about 25% of the surface area of the mounting surface, more preferably at least about 50% of the mounting surface area, even more preferably at least about 75% of the mounting surface area, and most preferably at least about 90% of the mounting surface area. One of skill in the art may select the proportion of the mounting surface that comprises the bonding region in order to yield a dental appliance that has a desired balance between desired performance property and bondability to the bonding agent used to bond the dental appliance to a substrate.

In order to further improve the bond strength between the dental appliance and a substrate, the mounting surface may include one or more irregularities including, but not limited to, texture, undercuts, recesses, protrusions, or other mechanical features designed to enhance mechanical interlocking between the bonding agent and the mounting surface, in addition to the aforementioned chemical adhesion. It is also contemplated that the performance region may be associated with the bonding region using any of these irregularities in order to enhance the bonding strength between the performance region and the bonding region.

As used herein, the term “bonding agent” refers to any dental adhesive, cement or glue to which the dental appliance may be adhered. The bonding agent is typically applied directly on the substrate or the mounting surface of the dental appliance. The bonding agent reacts with the mounting surface of the dental appliance to form a chemical and/or mechanical bond therebetween. The bonding agent can further solidify during and after mounting the dental appliance to the bonding agent.

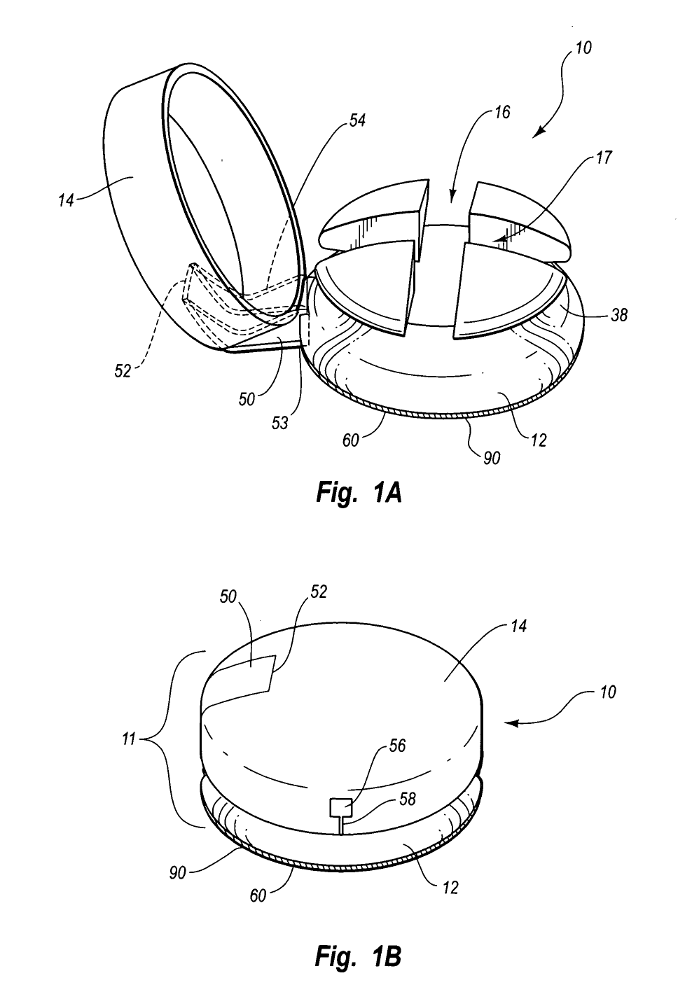

With these definitions in mind, attention will now turn to describing various embodiments of dental appliances having performance regions and bonding regions. With reference to FIGS. 1A and 1B, a bracket 10 is illustrated comprising a base 12 and a ligation cover 14 connected thereto. Bracket 10 is broadly categorized as a “self-ligating” bracket, which is herein defined as an orthodontic bracket that does not require the use of ligatures (i.e., ties, wires, elastics) to secure an arch wire thereto. The term “self-ligating bracket” refers to a class of orthodontic brackets that include some sort of ligation cover or clasp which encloses or otherwise retains the arch wire within a slot in the performance region. There are both “passive” and “active” self-ligating orthodontic brackets. The term “passive” bracket refers to brackets that only loosely retain the arch wire therein, such that considerable movement between the arch wire and performance region is possible. The term “active” bracket refers to brackets in which the self-ligating cover or clasp exerts force onto the arch wire, resulting in more precise and controlled tooth movement.

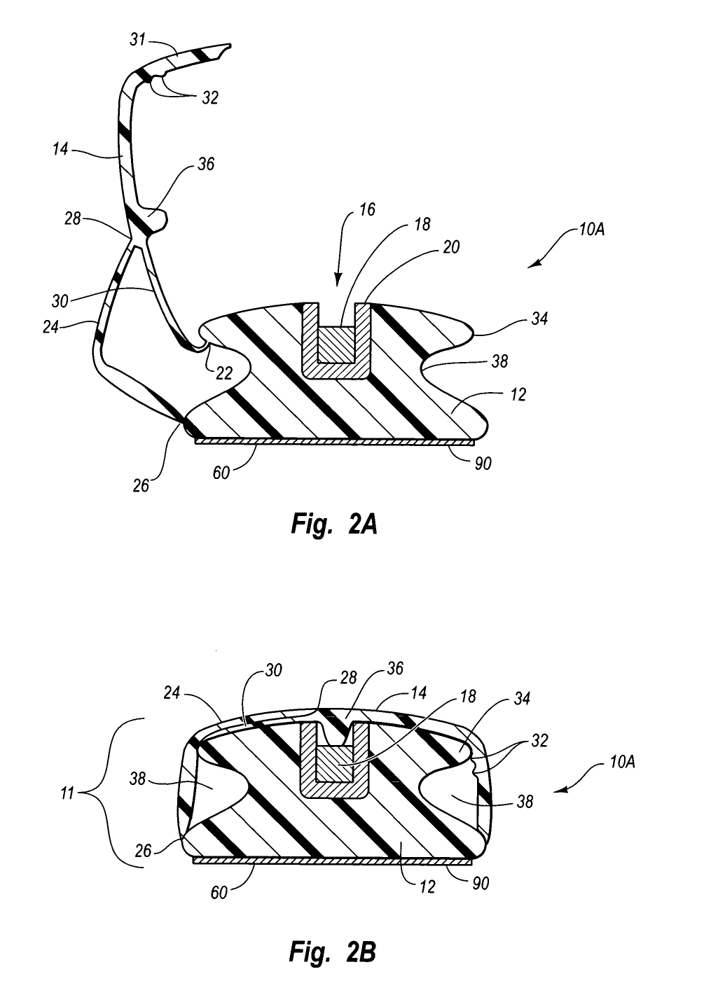

The base 12 is the portion of the bracket 10 that is attached or adhered to a substrate. The substrate can be a tooth or a band on the tooth. The base 12 includes an arch wire slot 16 for receiving an arch wire 18 (see FIGS. 2A and 2B) therein. Although shown as having a square cross section, the arch wire 18 can have any desired cross section, such as rectangular, circular, oval, and combinations thereof. The arch wire slot 16 can similarly have any desired configuration. The base 12 can also include an auxiliary arch wire slot 17 disposed transversely to arch wire slot 16. Auxiliary slot 17 may be used in the conventional manner to assist in fixing an arch wire within the arch wire slot 17, such as by means of wire or elastomeric ligatures.

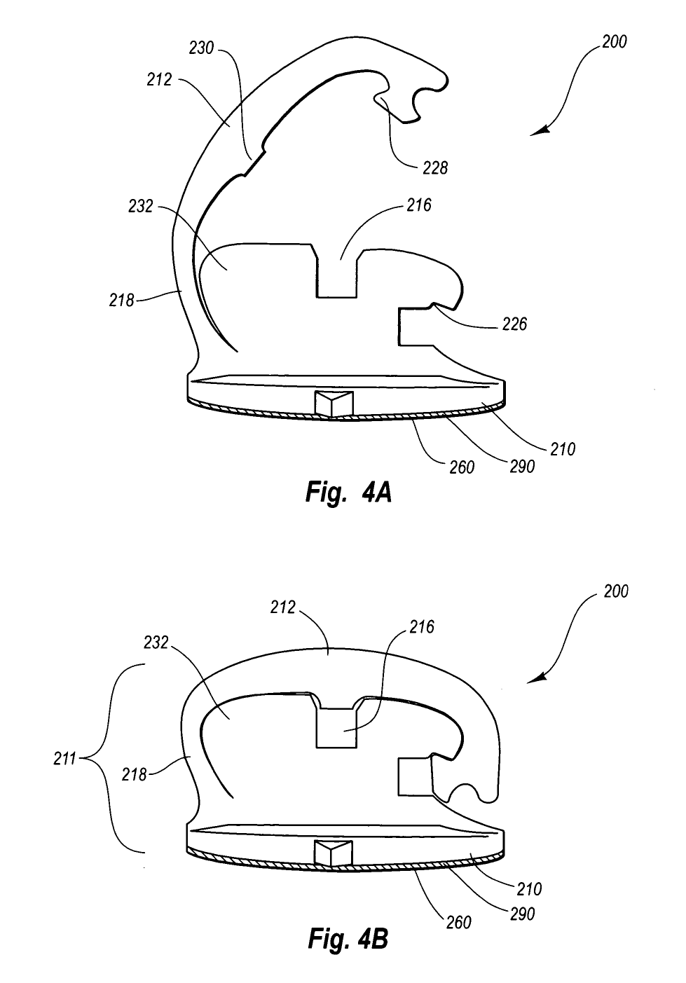

The base 12 can further include peripheral recesses 38 on either side, which can be used to optionally secure the arch wire 18 within the slot 16 using conventional wire or elastomeric ligatures. For example, peripheral recesses 38 can serve as a backup where the ligation cover 14 has been permanently removed or separated from the base 12 (e.g., by severing or tearing). Thus, when the ligation cover 14 is removed, the base 12 may at least approximately resemble a conventional bracket shown in FIG. 4.

Ligation cover 14 is joined to base 12 by a joint element 50. The ligation cover 14 is formed in a hood-like manner and is integrally connected to the joint element 50 by means of an integral hinge 52. In a preferred embodiment, the integral hinge 52 comprises an area or region of locally reduced cross-sectional thickness in order to provide increased flexibility in the hinge region. Such a hinge may be referred to as a “film hinge”. The joint element 50 merely acts as a connection between cover 14 and base 12. A recess 54 is advantageously provided in the outside of the cover 14 so that the joint element 50 and the cover 14 can nest together and form a single, smooth outer surface upon closing or locking the cover 14 with the base 12.

The base 12, ligation cover 14, and joint element 50 can either be integrally molded in a single step, so as to yield an integral, one-piece orthodontic bracket, or else an end of the joint element 50 opposite the integral hinge 52 may initially be detached from the base 12 and thereafter attached to the base 12, e.g., by pushing the end of joint element 50 into a corresponding groove within the base 12 in a form-locking manner. In this way, the ligation cover 14 and joint element 50 are insertably affixed to the base 12. In either embodiment, a further integral hinge 53, such as a film hinge, may be provided in the region of attachment between the joint element 50 and the base 12 so that the joint element 50, and thus also the ligation cover 14, can be pivoted about the hinge 53 in order to facilitate rotation of the cover 14 over and onto the base 12 during ligation.

An exit aperture 56 (FIG. 1B) is provided on each side of the ligation cover 14 to allow complete closure of the ligation cover 14 around an arch wire (not shown) placed within the arch wire slot 16. An insertion slot 58 extending from the exit aperture 56 to a lower edge of the ligation cover 14 permits the passage of the arch wire into and out of each exit aperture 56 during opening and closing of the cover 14.

The ligation cover 14 is the mechanism or means by which an arch wire is ligated or held in place within the arch wire slot. Alignment forces exerted by one or more arch wires to the performance region and/or cover are transferred to the tooth in order to urge the tooth into proper alignment. The self-ligating brackets 10 can include a wide variety of different performance regions and ligation covers having varying mechanical and functional features.

For example, in one embodiment of a bracket 10A shown in FIGS. 2A and 2B, cover 14 can be attached to base 12 using a spring mechanism. The ligation cover 14 can be generally L-shaped so as to hingedly connect to the base 12 at one end of the “L” (by hinge element 22 discussed below), and overlap and lock around the base 12 at the other end. A plurality of locking notches 32 within a latch member 31 assist in locking the ligation cover 14 over a protrusion 34 within the base 12. The notches 32 provide a plurality of locking positions, or degrees of closure, of the ligation cover 14 in order to provide the orthodontic practitioner with the ability to apply varying levels of force onto the arch wire 18. A bearing or holding cam 36 can extend downwardly from the ligation cover 14 and partially into the arch wire slot 16 when the cover 14 is in a closed or locked position (FIG. 2B) in order to apply direct pressure to the arch wire 18 and thereby provide active ligation.

A hinge element 22 integrally connects the ligation cover 14 to the base 12 and can comprise the same material. The hinge element 22 can be a film hinge. In this way, the ligation cover 14 and base 12 can be molded, such as by injection molding, in a single molding step to yield an integral, one-piece orthodontic bracket 10A. In this way, the film hinge 22 provides a center point or line of rotation about which the ligation cover 14 can be rotated back and forth between an open position, in which the arch wire slot 16 is completely open (FIG. 2A), and a closed or locked position, in which the arch wire slot 16 is completely enclosed in order to provide ligation of an arch wire disposed therein (FIG. 2B).

A spring element 24 interconnects the ligation cover 14 and the base 12. The spring element 24 can also comprise the same material as ligation cover 14 and base 12 such that the entire bracket 10A can be molded as a single piece. The spring element 24 is connected to the performance region by hinge element 26 and to the ligation cover 14 by hinge element 28. Hinge elements 26 and 28 are also depicted as comprising film hinges of reduced cross-sectional thickness. Nevertheless, the spring element 24 may be attached to the cover 14 and base 12 using any desired hinge or other connection means known in the art. In order for the spring element 24 to lay substantially flush with the ligation cover 14 when the cover is in a closed and locked position, the cover 14 may include a region 30 of reduced cross section into which the spring element 24 can insert itself during closure of the ligation cover 14. In this way, the ligation cover 14 and spring element 24 yield a smooth, continuous and uniform upper surface when closed. This, in turn, reduces the tendency of food, plaque or other debris to become lodged in the orthodontic bracket 10A while in use. It also yields a bracket having a minimum of uncomfortable jagged edges compared to conventional brackets.

Spring element 24 acts to urge the ligation cover 14 to remain open while in the open position depicted in FIG. 2A, and to remain closed while in the closed position depicted in FIG. 2B. Details of how this is accomplished are disclosed in U.S. Pat. No. 6,695,612, filed Aug. 15, 2002, the disclosure of which is hereby incorporated by reference.

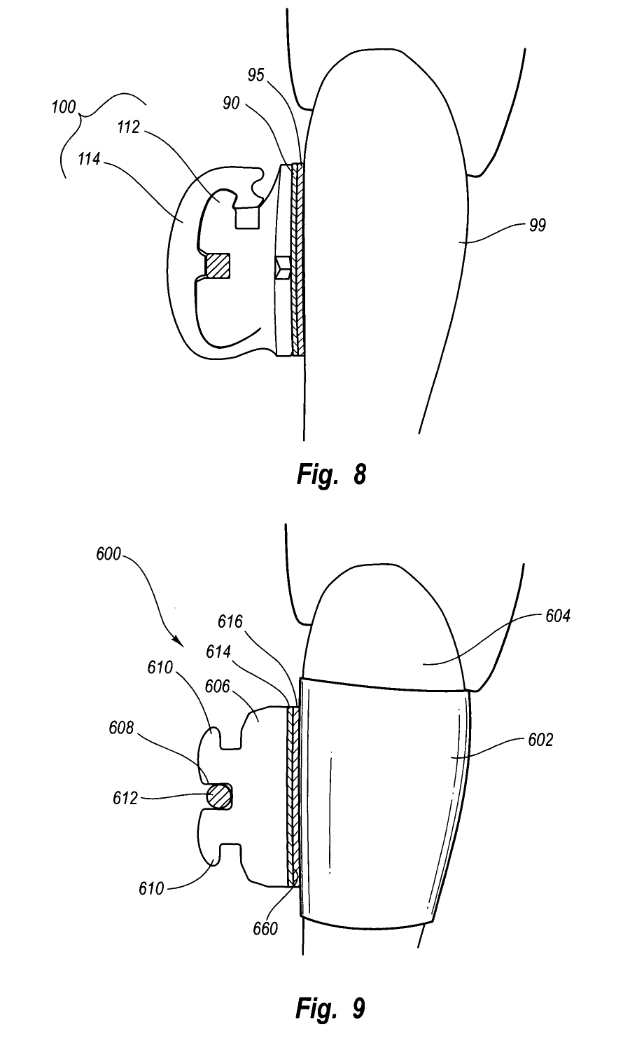

In bracket 10 and 10A, the base 12 includes a bonding region 90 in the form of a discrete layer. Note that the term “bottom” is used only to illustrate the location of the bonding region 90 in FIG. 1A, 1B, 2A and 2B and is not limiting to the invention. When in use, the base 12 is actually turned on its side when being applied to a substrate (see FIG. 8) so that the bonding region 90 is vertical. A performance region 11 is thus defined as the cover 14 and the portion of the base 12 that does not include the bonding region 90. Methods for forming the performance region and the bonding region will be discussed further below.

The bonding region 90 forms a mounting surface 60. In this embodiment, the mounting surface 60 is comprised solely of the bonding region 90. As shown in FIG. 8, the bracket 10 mounts to a substrate, tooth 99. Mounting surface 60 is configured to interface between the bracket 10 and a bonding agent 95 placed on the tooth 99. The bonding agent 95 can be any suitable dental adhesive, cement or glue. Preferably, the bonding region 90 is more compatible and provides a higher-strength bonding interaction with the bonding agent 95 than the performance region 11.

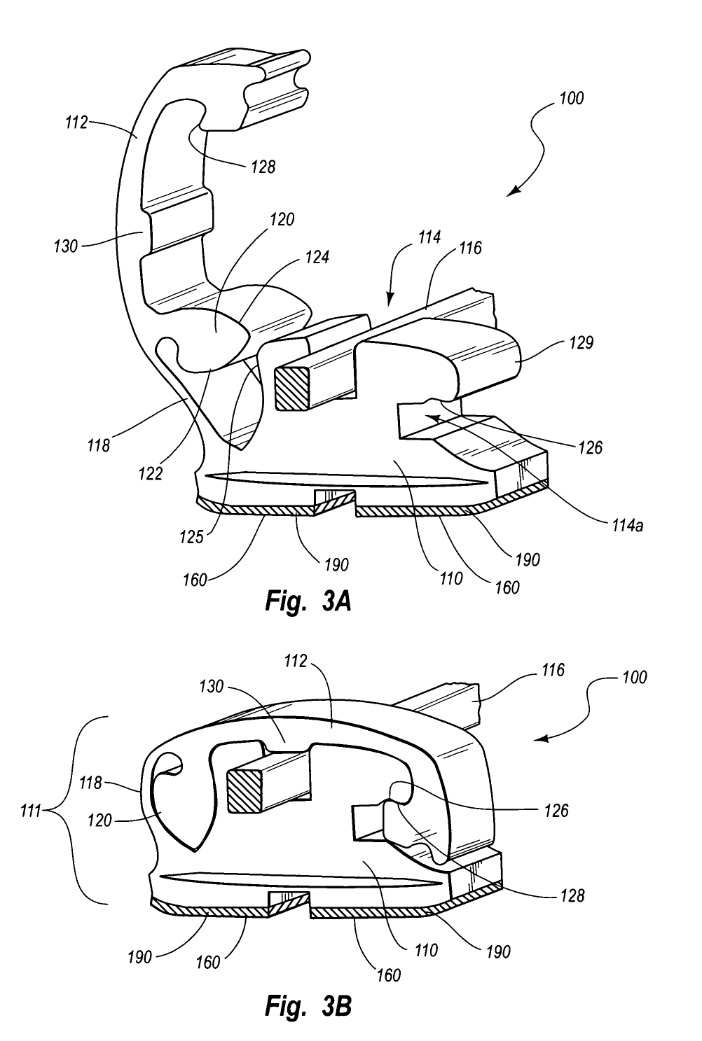

Another configuration for forming bracket 10 is shown in FIGS. 3A and 3B. The orthodontic bracket 100 has a base 110 to which a ligation cover 112 is hingedly attached. A slot 114 open to the upper side of the base 110 is provided near the center of said base 110 and serves for the insertion of an arch wire 116 therein. An additional arch wire slot 114a may also be provided.

The ligation cover 112 is hingedly connected to the base 110 by an elongated film hinge 118. The ligation cover 112 is such that it may be selectively rotated between an open and a closed position relative to the arch wire slot 114, with the ligation cover 112 maintaining the arch wire 116 within the slot 114 when the ligation cover 112 is in the closed, ligating position. The elongated film hinge 118 preferably has a length and thickness that are selected so that the hinge 118 has a desired level of strength, elasticity, flexibility and toughness. In one embodiment, the elongated film hinge 118 has a thickness of at least about 0.2 mm.

The film hinge 118 of this embodiment is designed to bend along substantially its entire length rather than at a single point or line. This helps the hinge resist fatigue or fracture better than film hinges that bend along a single line. In embodiments which include an amorphous polymer, the amorphous component of the blend provides enhanced elasticity, flexibility, and toughness, especially important in the area of the elongated film hinge 118. Elasticity, flexibility, and toughness help the hinge 118 to not become fatigued or broken after repeated bending.

Bracket 100 includes an interactive cam structure 120 with a first curved surface 122 and a second curved surface 124. The first curved surface 122 interacts with the elongated film hinge 118 to provide a curved surface that helps ensure that the elongated film hinge 118 bends gradually over its entire length rather than abruptly at any specific locale. The second curved surface 122 is curved in such a way so that it interacts with a corresponding wall 125 of the base 110 so to bias the ligation cover 112 toward an open position relative to the base 110 when the ligation cover 112 is in the open position. This improves access to arch wire slot 114, making insertion or removal of the arch wire 116 easier. The second curved surface 124 may, depending on the shape of the corresponding wall 125 of the base 110, also act to bias the ligation cover 112 to remain in a closed position when in the closed position relative to the base 110.

An angled keyway 126 is provided near one end of the base 110. The cover 112 contains a corresponding locking tongue 128 that enables the ligation cover 112 to be selectively locked or unlocked relative to the base 110. The ligation cover 112 is locked to base 110 (as seen in FIG. 3B) by closing the cover 112 so that the locking tongue 128 is inserted into angled keyway 126.

In the event that the arch wire 116 pushes against the cover 112 with sufficient force to cause the cover to bulge upwardly relative to the base 110, rather than causing the tongue 128 to withdraw from the angled keyway 126, which could result in undesired disengagement of the cover 112, the locking tongue 128 is instead pulled more deeply into the angled keyway 126, thereby tightening the locking mechanism. This provides added safety, and in order to open the cover, the locking tongue 128 is pulled out of angled keyway 126 and over an outer protrusion 129 of the base 110.

Furthermore, a bearing protrusion 130 is provided at the inside and middle of the cover 112 to assist in fixing the arch wire 116 in the slot 114 while the cover 112 is in the closed state (FIG. 3B). The bearing protrusion 130 reduces the play in the system by effectively widening the ligation cover 112 in the vicinity of the arch wire slot 114.

Base 110 also includes bonding regions 190 formed on the bottom of the base. The boundaries of the bonding regions 190 and the rest of base 110 can be contiguous. The bonding regions 190 form mounting surfaces 160. In this embodiment, the bonding regions 190 form substantially all of the surface area of the mounting surfaces 190. Thus, a significant portion of the bonding regions 190 is available to bond with the bonding agent. A performance region 111 is thus defined as the cover 112 and the portion of the base 110 that does not include the bonding regions 190. Preferably, the bonding regions 190 are more compatible and provide a higher-strength bonding interaction with a bonding agent than the performance region 111.

FIGS. 4A and 4B depict an alternative embodiment of an orthodontic bracket 200 according to the invention that does not include a cam structure. Instead, the orthodontic bracket 200 depicted in FIGS. 4A and 4B includes a base 210 and a ligation cover 212 attached to the base 210 by means of an elongate film hinge 218, an angled keyway 226, a locking tongue 228, and a bearing protrusion 230. The base 210 further includes a curved end 232 that acts as a hinge guide in order to cause the elongate film hinge 218 to bend gradually over a significant portion of its entire length. In this way, the curved end 232 of the base 210 can substitute for curved hinge-guiding surface 122 of cam structure 120 of the orthodontic bracket 100 depicted in FIGS. 3A and 3B. Thus, as the ligation cover 212 is moved from an open, non-ligating position (FIG. 4A) to a closed, ligating position (FIG. 4B), the elongate film hinge 218 at least partially abuts the curved end 232 and bend gradually around the curved end 232 so as to better distribute the bending forces and bending angles along substantially the entire length of the elongate film hinge 218. Base 210 also includes a bonding region 290 in the form of a discrete layer which forms a mounting surface 260 to increase the bondability of dental appliance 200 to a bonding agent.

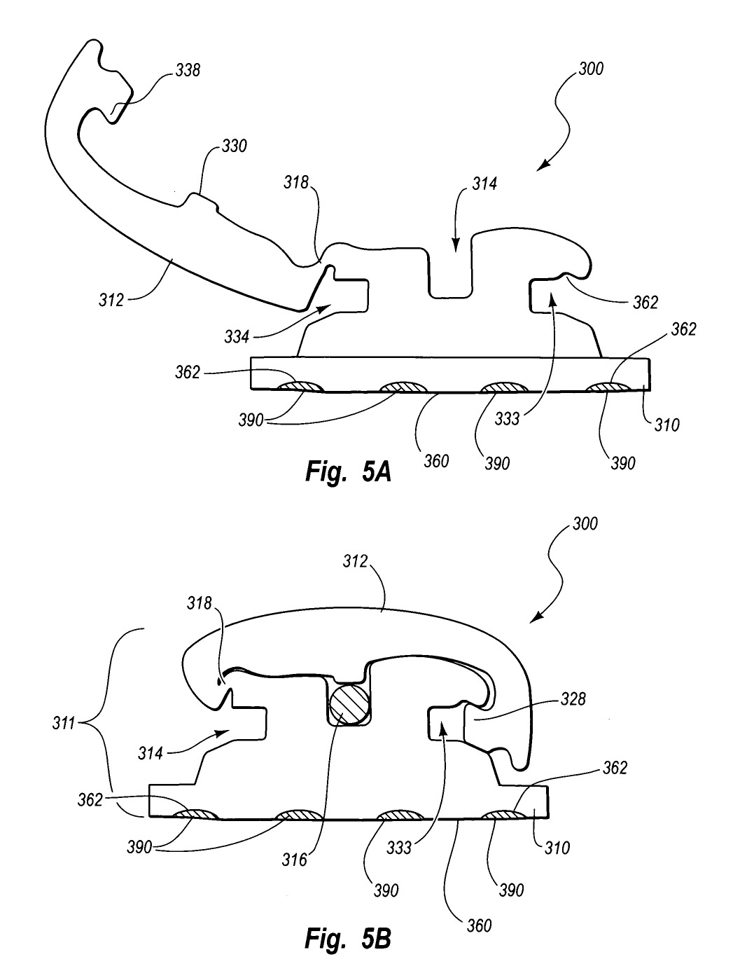

FIGS. 5A and 5B illustrate an alternative bracket embodiment 300 which is similar to the bracket 100 illustrated in FIGS. 3A and 3B in that it includes a base 310, a ligation cover 312, a slot 314, an arch wire 316 (seen in FIG. 5B), an angled keyway 326, a locking tongue 328, and a bearing protrusion 330. This example differs from the bracket 100 illustrated in FIGS. 3A and 3B in that the hinge 318 is not as elongated as hinge 118. Bracket 300 may further include additional arch wire slots 333 and 334 for use with additional or alternative arch wires as known in the art.

Base 310 includes a plurality of bonding regions 390. In this embodiment, base 310 includes a plurality of recesses 362 into which are disposed material for the bonding regions 390. The performance region 311 for this embodiment includes the cover 312 and the portion of base 310 that does not include the bonding regions 390. Recesses 362 are one example of irregularities in the performance region 310 that can be formed to increase the chemical and mechanical bond between the performance region 311 and the bonding regions 390.

In this embodiment, mounting surface 360 is formed from a combination of the performance region 311 and bonding regions 390 so that the bonding regions 390 form only a percentage of the surface area of the mounting surface 360. The mounting surface 360 is configured to mount to a substrate wherein the bonding regions 390 are more compatible with the bonding agent than the performance region 311.

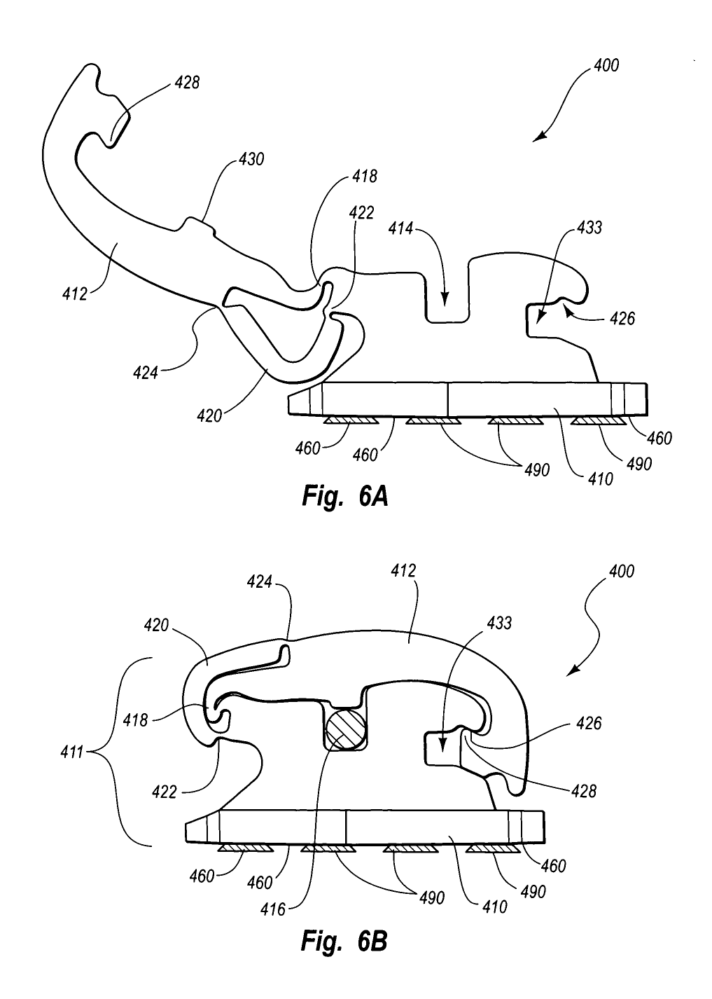

FIGS. 6A and 6B illustrate an alternative bracket 400 including a base 410, a ligation cover 412, a slot 414, an arch wire 416 (seen in FIG. 6B), a main film hinge 418, an angled keyway 426, a locking tongue 428, a bearing protrusion 430, and an additional arch wire slot 433. This example differs from that illustrated in FIGS. 5A and 5B in that it further has a spring element 420 attached at one end of the base 410 by a film hinge 422 and at an opposite end to the ligation cover 412 by a film hinge 424.

Base 410 includes a plurality of bonding regions 490 extending outwardly. The performance region 411 thus includes the cover 412 and the portion of the base 410 that does not include the bonding regions 490. A mounting surface 460 is formed from bonding regions 490 and from performance region 411. In this embodiment, the mounting surface 460 is not rectilinear as is the case for FIGS. 1 through 5. Rather, the mounting surface 460 includes irregularities to assist the mounting surface in bonding to a substrate. The bonding regions 490 are trapezoidal in shape so that they form undercuts against the performance region 411. The undercuts can increase the mechanical bonding strength between the mounting surface 460 and a bonding agent. In addition, the undercuts provide increased surface area for chemical bonding to occur between the mounting surface 460 and the bonding agent.

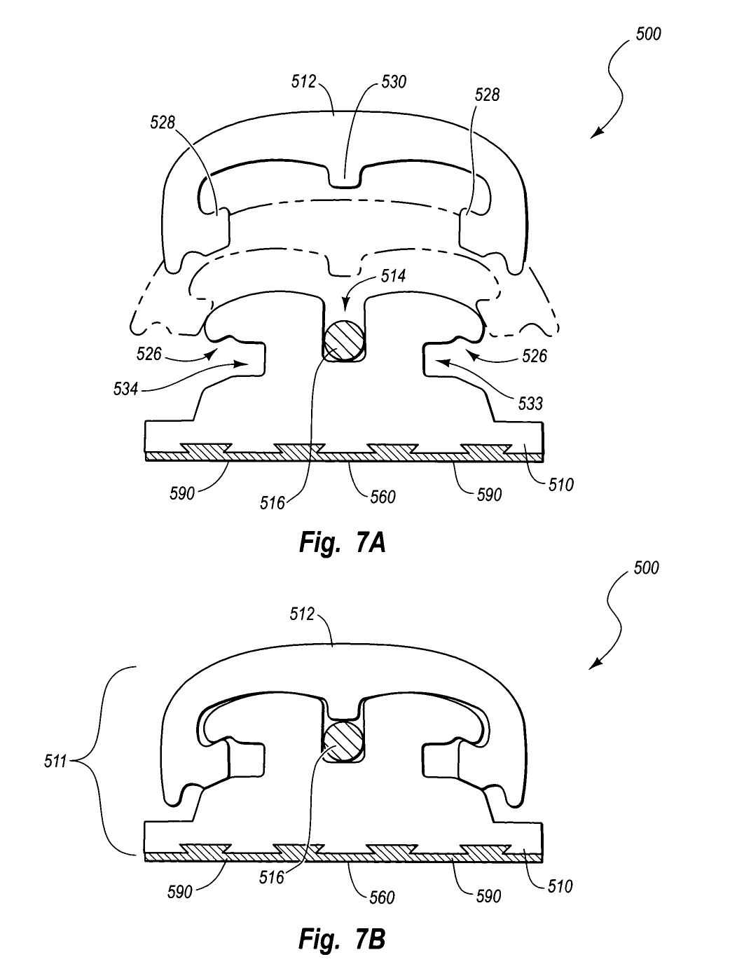

FIGS. 7A and 7B illustrate yet another alternative bracket 500 including a base 510, a ligation cover 512, a slot 514, an arch wire 516, a pair of angled keyways 526, a pair of locking tongues 528, a bearing protrusion 530, and additional arch wire slots 533 and 534. This example differs from that illustrated in FIGS. 1-5 in that it includes no hinge between the base 510 and the cover 512. The base 510 could be used without the cover 512 as a traditional bracket requiring ligatures. Using the cover 512 results in a self-ligating bracket with a uniform, closed, smooth surface across the top surface of the bracket 500, which is beneficial for patient comfort and hygiene.

Base 510 includes a bonding region 590. Bonding region 590 forms a mounting surface 560. In this embodiment, the bonding region 590 forms the entire surface area of the mounting surface 560. This embodiment illustrates that the performance region 511 and the bonding region 590 can be bonded together at an irregular surface. This can increase the bonding strength between the performance region 511 and the bonding region 590 by increasing both mechanical bonding and chemical bonding therebetween.

It will be appreciated that each of brackets 100, 200, 300, 400 and 500 can be disposed on a substrate similar to that shown in FIG. 8. In addition, the bonding regions formed on the bases of these brackets forms a high-strength bond with a bonding agent applied to the substrate. Various other self-ligating bracket designs are disclosed in U.S. Pat. No. 6,607,383; U.S. application Ser. No. 09/914,737, filed Aug. 29, 2001, abandoned; and U.S. application Ser. No. 09/953,400, filed Sep. 12, 2001. For purposes of disclosing exemplary orthodontic self-ligating bracket designs, the foregoing U.S. applications and patent are incorporated by reference.

While FIG. 8 illustrates that tooth 99 can be a substrate, FIG. 9 illustrates that the dental appliance can also be attached to another substrate which is not a tooth. In FIG. 9, a conventional bracket 600 is attached to a band 602. The band 602 is, in turn, attached to a tooth 604. The bracket 600 includes a base 606 and an arch wire slot 608. A pair of opposing tie wings 610 is disposed on opposing sides of the base 606. The tie wings 610 are configured to receive ligatures which secure an arch wire 612 in arch wire slot 608. Base 606 includes a bonding region 614 forming a mounting surface 660. The bonding region 614 assists in bonding the bracket 600 to a bonding agent 616 disposed on band 602. Thus, in this embodiment, the “performance region” is the portion of the base 606 that does not include bonding region 614 and the “substrate” is the band 602.

With reference to FIG. 9, however, the band 602 could also be considered to be a “performance region”. FIG. 9 illustrates that the band 602 includes an outer surface 618 and an inner surface 620. The inner surface 620 serves as a “mounting surface” for attaching the band 602 to the tooth 604. The inner surface 602 includes a bonding region 620 applied thereon. The bonding region 620 assists in bonding the performance region 602 to a bonding agent 622 applied to the tooth 604. Thus, in this case, the “performance region” is the band 602 and the “substrate” is the tooth 604.

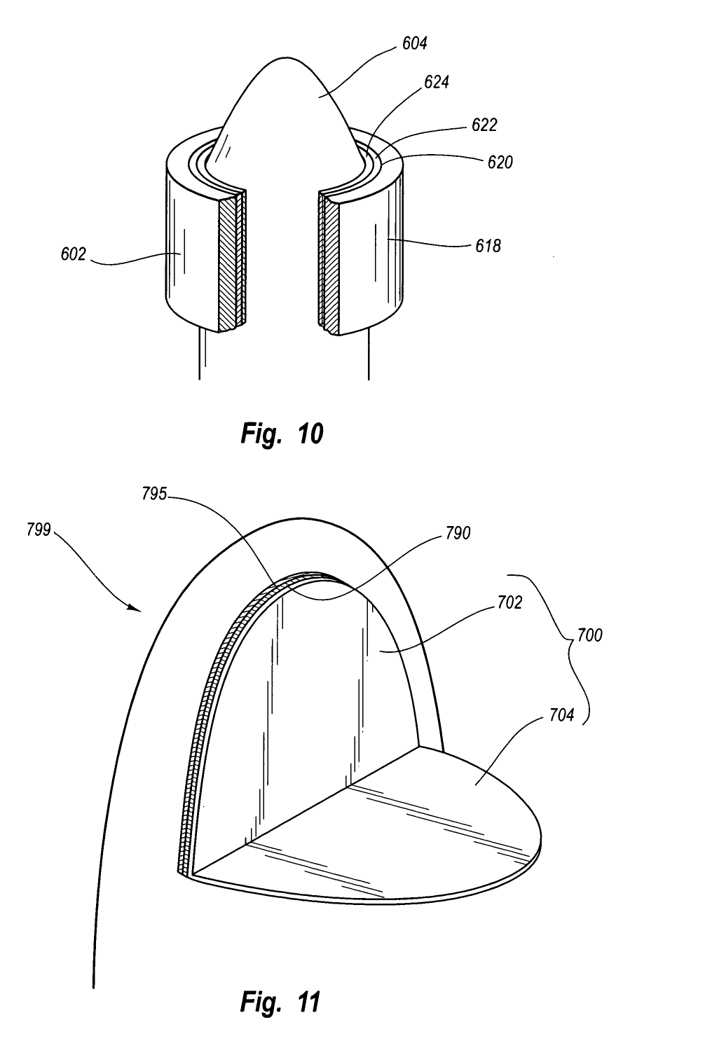

Turning now to FIG. 10, the dental appliance could be a bite ramp 700. Bite ramps typically include a base 702 and a ramp element 704. The base 702 is sized and configured to bond to the lingual surface of a patient's front tooth 799 (e.g., an upper or lower incisor and/or canine), while the ramp element 704 is hingedly or bendably adjustable relative to the base 702. The ramp element 704 provides a ramp structure at a desired angle for engaging the corresponding teeth of the opposite dental arch (e.g., the upper or lower incisors and/or canines) when the patient's mouth is closed. The engagement between the ramp structure 704 and the corresponding teeth of the opposite dental arch causes the lower jaw to move forward relative to the upper jaw, while also disoccluding the lateral teeth and allowing a new neutral occlusion. The bite ramp 700 may also be used in combination with class II elastics to move the lower jaw forward.

In one embodiment, the bite ramp 700 can be adjustable such that the ramp element 704 is selectively adjustable in relation to the base 702. The bite ramp 700 may further comprise means for locking the ramp element 704 in a desired adjustment angle relative to the base 702. An example of such a means for locking is a curable resin that is applied to and cured between the base 702 and ramp element 704. The cured resin locks the ramp element 704 in a desired adjustment angle, and provides a more comfortable surface for the patient's tongue and soft tissues. In one embodiment, an optional shoe (not shown) may be placed over the ramp element 704. The lower surface of the shoe provides the ramp element 704 for engaging the corresponding tooth of the opposite dental arch. The upper surface of the shoe provides a smoother surface within the patient's mouth (e.g., to provide enhanced comfort and/or to help prevent buildup of plaque or other foreign matter). An adjustable bite ramp with an optional shoe is described in more detail in U.S. patent Ser. No. 10/835,963, filed Apr. 30, 2004, the disclosure of which is hereby incorporated by reference. The bite ramp 700 includes a bonding region 790 formed on the base 702 which is configured to bond to a bonding agent 795 disposed on a tooth 799.

It will thus be appreciated that the present invention broadly applies to a wide range of dental appliances in which is it desired to more strongly bond the dental appliance to a substrate.

The materials of the performance region and the bonding regions of the dental appliances of the present invention will now be discussed in detail. The performance region advantageously comprises one or more performance properties listed above, and for this reason, can compose a majority of the volume of the dental appliance. However, it is not required that the performance region provide a majority of the volume of the dental appliance. In most embodiments, the performance region exhibits superior performance property than the bonding region.

The proportion or ratio between the performance region and bonding region can be selected to impart any desired balance between bondability, on the one hand, and desired performance properties, on the other. According to one embodiment, it may be desirable to minimize the size or proportion of the bonding region to only so much as may be needed to yield a dental appliance having a desired level of bondability to one or more bonding agents. In that way, the desired performance properties can be maximized while still providing a desired level of bondability. Consistent with this, it may be desirable to minimize the thickness of the bonding region and maximize the thickness of the performance region since only the surface of the bonding region chemically interacts with the bonding agent.

In general, the performance region preferably comprises at least about 25% by volume of the dental appliance, more preferably at least about 50% by volume of the dental appliance, even more preferably at least about 75% by volume of the dental appliance, and most preferably at least about 90% by volume of the dental appliance. Conversely, the bonding region preferably comprises up to about 75% by volume of the dental appliance, more preferably up to about 50% by volume of the dental appliance, even more preferably up to about 25% by volume of the dental appliance, and most preferably up to about 10% by volume of the dental appliance.

Thus, the performance region can be made from any suitable material, or groups of materials, having desired performance properties, such as strength, rigidity, durability, flexibility, resilience, moldability, or machinability. The performance region may comprise a material that is partially or wholly for aesthetic purposes (e.g., color, shape, etc.). Examples of materials that have been found to exhibit desired properties within various performance properties include, but are not limited to, a wide variety of polymeric materials (including both thermoset and thermoplastic polymers), metals, metal alloys, ceramics, and combinations thereof.

Suitable polymers broadly include thermoplastic and thermoset materials or those materials which have suitable properties of moldability and hardenability. In general, polymers that result in harder plastics are generally preferred in order to provide a rigid, stable performance region. Of course, virtually any polymer that can safely be employed in a person's mouth, and that has sufficient strength, toughness and rigidity for use as a performance region, is within the scope of the invention. Softer, more flexible polymers such as polyethylene and polypropylene may be suitably employed in some portions of the dental appliance (e.g., ligation covers), particularly where it is desired for that portion of the dental appliance to have more resiliency or flexibility.

Examples of polymeric materials that can be included in the performance region include, but are not limited to, more crystalline polyamides, acetal polymers, urethanes, polyetherimides, polycarbonates, polysulphones, polyethersulphones, polyethylene terapthalate, polyethylene teraphthalate glycol, acrylics, polyarylether ketones, polyethylene, polypropylene, polyaramides, polyesters, polyarylamides, and combinations thereof.

In one embodiment, crystalline polymers are desirable to construct the performance region. Crystalline polymers are unique in the sense that they form strong, crystalline bonds. However, because the polymers in crystalline polymers are usually never perfectly aligned, the crystalline polymer also has some slightly amorphous qualities. This results in an extremely strong material which can also be flexible and resilient. Such qualities can be ideal in some dental appliances, for example a self-ligating bracket having a performance region and ligation cover in which the hinge connection between the performance region and ligation cover can experience repeated bending and flexing. In one embodiment, the crystalline polymer may be blended with an amorphous polymer, so as to lend enhanced elasticity, flexibility, and toughness to the hinge connection of the bracket.

In addition, crystalline polymers lend increased strength, rigidity and durability, which can be important in the region of the performance region around the arch wire slot(s). Strength, rigidity and durability around the arch wire slots prevents or substantially inhibits deformation that may otherwise result because of the mechanical forces transmitted to the performance region from the arch wire as the teeth are urged into proper alignment. U.S. patent Ser. No. 10/835,959, filed Apr. 30, 2004 discusses embodiments of self-ligating brackets which are constructed of suitable crystalline polymers, which disclosure is hereby incorporated by reference.

In some embodiments, the performance region can be made from a single material in a single piece, which may be more cost effective from the standpoint of manufacturing costs, as well as providing greater ease of use. In the case where a more rigid plastic is used (e.g., the base (except for the bonding region)), and a more flexible plastic is used (e.g., the ligation cover), it will typically be advantageous to separately mold the base and ligation cover and then thermally fuse them together to form a single, integrally connected bracket. This procedure is sometimes referred to in the art of molding as “two-color molding”, which refers to the fact that two different plastic materials are molded or fused together to form a single integral, or one-piece, article of manufacture.

Plastics and ceramics can be reinforced with suitable materials to strengthen the resulting performance region. For example, reinforcing particles (not shown) or a reinforcement insert (not shown) that is made of metal, ceramic, glass, fibers or a more durable plastic can comport to the performance region greater durability and resistance to wear. Reinforcements can be localized at particular locations where the performance region may experience more stress, for example where it comes into contact with an arch wire. In an exemplary molding process, the base may be molded around a metallic, ceramic, or other reinforcement insert. Alternatively, for reinforcement particles, the plastic precursor can be mixed with reinforcement particles. Other portions of the dental appliance may likewise incorporate a metal feature. For example, the ligation cover can include a metal feature that comes into direct contact with the arch wire to provide greater durability.

In one embodiment, the performance region is reinforced with TFG Type 3 glass (“c-glass”) or other appropriate fibers which increases flexibility, toughness, and resilience. These characteristics can be particularly beneficial in dental appliances having a hinge portion (e.g., self-ligating bracket). Reinforcement with c-glass fibers, which are characterized by relatively small diameters, high flexibility, and short fiber length, results in substantial improvement of flexibility, toughness, and resilience as compared to other reinforcement materials. Maintaining flexibility of the polymeric material, while providing increased strength and resistance to creep, is particularly beneficial in the case where an orthodontic bracket includes a living hinge that is expected to flex back and forth several, and often numerous, times during the lifespan of the bracket. U.S. patent Ser. No. 10/835,744, filed Apr. 30, 2004 describes embodiments of self-ligating brackets constructed of a plastic reinforced with c-glass, which disclosure is incorporated by reference.

Other reinforcement materials include, but are not limited to, silica, aluminum hydroxide, wollastonite, spinel, titanium dioxide, feldspar, silicas, calcium carbonate, talc, micas, calcium silicates, metals, and combinations or mixtures thereof. Ceramic material can be, but is not limited to, zirconium oxide, aluminum oxide, magnesium oxide and/or silicon oxide or mixtures thereof.

Additives which increase the bond between the plastic material and reinforcement material can be used, for example, but not limited to, organo-functional silanes. In addition, the present invention contemplates that performance region can include coating which reduces staining or abrasion.

Examples of metals and metal alloys include, but are not limited to, stainless steel, stainless steel alloys, titanium, and nickel-titanium alloys.

Examples of ceramics include metal oxides, metal carbides, and metal nitrides.

The bonding region is generally more compatible with a bonding agent than the performance region. Generally, the bonding region typically provides less of the volume of the dental appliance. In addition, the bonding region can provide less performance properties than the performance region. Examples of materials that have been found to be especially compatible with bonding agents known in the art, and therefore suitable for use in making the bonding region, include, but are not limited to, less crystalline polyamides, methacrylates, acrylates, polycarbonates, metal oxides, ceramics, and combinations thereof. Examples of metal oxides that can be incorporated into the bonding region include, but are not limited to, alumina, silica, zirconia, and titanium dioxide. Examples of ceramics include metal oxides, metal carbides, and metal nitrides.

It should be understood that each of the performance and bonding regions may comprise a single material or region. Alternatively, one or both of the performance and bonding regions may comprise two or more different types of materials, either blended together and/or that comprise discrete subregions. Moreover, while the performance and bonding regions will generally comprise different materials overall, it is possible for the performance region to include two or more materials, with one or more of the materials being the same as or similar to one or more materials found in the bonding region. Similarly, it is possible for the bonding region to include two or more materials, with one or more of the materials being the same as or similar to one or more materials found in the performance region.

The materials used to form the performance and bonding regions can be formed and/or brought together using any desired process. For example, according to one embodiment, the materials used to form the performance and bonding regions can be co-molded and/or co-extruded together (e.g., using known 2-color molding processes). This process is especially suitable where two or more different polymeric materials or used to form different regions or segments of the dental appliance.

In another embodiment, the performance and bonding regions can be formed separately and then joined together using known processes. In the case where a fired ceramic material and/or a molded or stamped metal is used in combination with a polymeric material, the ceramic material or metal will typically be formed or shaped in a separate process, followed by attachment of the polymeric material thereto.

According to one embodiment, the performance region of the dental appliance can be formed initially, followed by formation of the bonding region thereto, e.g., by overmolding, mechanical attachment, spraying, dipping, brushing, bonding, or a combination thereof. In the case where the bonding region comprises a polymeric material that is initially in a flowable state, the polymeric material is typically caused to solidify, e.g., by chemical, light or heat curing, cooling, and the like. This procedure may be used, for example, in the case where the performance region comprises a metal or ceramic that is formed using a high temperature molding or firing process and the bonding region comprises a polymeric material that would be destroyed during formation or molding of the ceramic or metal material. It may also be used in the case where a polymeric material used in the formation of the performance region is processed differently than a polymeric material used in the formation of the bonding region.

According to another embodiment, the bonding region can be formed initially, followed by formation of the performance region thereto, e.g., by overmolding or mechanical attachment. This procedure may be used, for example, in the case where the bonding region comprises a ceramic material and the performance region comprises a polymeric material or metal that would be destroyed or altered during formation of the ceramic material. It may also be used in the case where a polymeric material used in the formation of the bonding region is processed differently than a polymeric material used in the formation of the performance region.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dental appliance comprising:
a mounting surface oriented so as to face a substrate to which the dental appliance is attached during use;
a performance region comprising at least one material that imparts at least one desired performance property to the dental appliance; and
a bonding region separate from the performance region and comprising at least a portion of said mounting surface, the bonding region comprising at least one material that differs from at least one material comprising the performance region and that causes a bonding agent to chemically bond more strongly to the bonding region than to the performance region.

2. The dental appliance as recited in claim 1, the bonding region comprising at least about 25% of the surface area of the mounting surface.

3. The dental appliance as recited in claim 1, the bonding region comprising at least about 50% of the surface area of the mounting surface.

4. The dental appliance as recited in claim 1, the bonding region comprising at least about 75% of the surface area of the mounting surface.

5. The dental appliance as recited in claim 1, the bonding region comprising at least about 90% of the surface area of the mounting surface.

6. The dental appliance as recited in claim 1, the performance region comprising at least about 25% by volume of the dental appliance.

7. The dental appliance as recited in claim 1, the performance region comprising at least about 50% by volume of the dental appliance.

8. The dental appliance as recited in claim 1, the performance region comprising at least about 75% by volume of the dental appliance.

9. The dental appliance as recited in claim 1, the performance region comprising at least about 90% by volume of the dental appliance.

10. The dental appliance as recited in claim 1, the performance region comprising at least one material selected from the group comprising polymeric materials, metals, and ceramics.

11. The dental appliance as recited in claim 1, the performance region comprising at least one polymeric material selected from the group comprising polyamides, acetal polymers, urethanes, polyetherimides, polycarbonates, polysulphones, polyethersulphones, polyethylene terapthalate, polyethylene teraphthalate glycol, acrylics, polyarylether ketones, polyethylene, polypropylene, polyaramides, polyesters, and polyarylamides.

12. The dental appliance as recited in claim 1, the performance region comprising at least one metal selected from the group comprising stainless steel, stainless steel alloys, titanium, and nickel-titanium alloys.

13. The dental appliance as recited in claim 1, the bonding region comprising at least one of polymeric materials, ceramics, or metal oxides.

14. The dental appliance as recited in claim 1, the bonding region comprising at least one polymeric material selected from the group comprising polyamides, methacrylates, acrylates, and polycarbonates.

15. The dental appliance as recited in claim 1, the bonding region comprising at least one metal oxide selected from the group comprising alumina, silica, zirconia, and titanium dioxide.

16. The dental appliance as recited in claim 1, the mounting surface further comprising one or more irregularities that increase mechanical bond strength between the mounting surface and a bonding agent during use.

17. The dental appliance as recited in claim 1, the bonding region comprising a single continuous region.

18. The dental appliance as recited in claim 1, the bonding region comprising a plurality of non-continuous regions.

19. The dental appliance as recited in claim 1, the bonding region comprising a single material or a uniform blend of materials.

20. The dental appliance as recited in claim 1, the bonding region comprising a plurality of subregions comprising different materials.

21. The dental appliance as recited in claim 1, the performance region comprising a single continuous region.

22. The dental appliance as recited in claim 1, the performance region comprising a single material or a uniform blend of materials.

23. The dental appliance as recited in claim 1, the performance region comprising a plurality of subregions comprising different materials.

24. A dental appliance comprising:
a mounting surface oriented so as to face a substrate to which the dental appliance is attached during use;
a performance region comprising at least one material that imparts at least one desired performance property to the dental appliance,
the material comprising the performance region comprising at least one member selected from the group comprising polymeric materials, metals, and ceramics; and
a bonding region separate from the performance region and comprising at least a portion of said mounting surface,
the material comprising the bonding region comprising at least one member selected from the group comprising polymeric materials, ceramics, and metal oxide,
the bonding region comprising at least one material that differs from at least one material comprising the performance region and that causes a bonding agent to chemically bond more strongly to the bonding region than to the performance region.

25. A method of manufacturing a dental appliance configured to mount to a substrate, the method comprising:
forming a performance region comprising at least one material that imparts at least one desired performance property to the dental appliance; and
associating a bonding region with the performance region,
the bonding region comprising at least one material that differs from at least one material comprising the performance region, the bonding region being selected to more strongly bond to a bonding agent than the performance region,
the bonding region forming at least a portion of a mounting surface on an exterior of the dental appliance.

26. The method as recited in claim 25, wherein associating the bonding region with the performance region comprises co-molding the performance region and the bonding region.

27. The method as recited in claim 25, wherein associating the bonding region with the performance region comprises forming an irregular interface between the performance region and the bonding region.

28. The method as recited in claim 25, wherein associating the bonding region with the performance region comprises applying the bonding region to the mounting surface using at least one of spraying, dipping, brushing, or a combination thereof.

29. The method as recited in claim 28, further comprising subsequently curing the bonding region.

30. The method as recited in claim 25, wherein the bonding region comprises at least one polymeric material selected from the group comprising polyamides, methacrylates, acrylates, and polycarbonates.

31. The method as recited in claim 25, wherein the bonding region comprises at least one of a metal oxide or ceramic.

32. The method as recited in claim 25, wherein the performance region comprises at least one material selected from the group comprising polymeric materials, metals, and ceramics.

33. The method as recited in claim 25, wherein the performance region comprises at least one polymeric material selected from the group comprising polyamides, acetal polymers, urethanes, polyetherimides, polycarbonates, polysulphones, polyethersulphones, polyethylene terapthalate, polyethylene teraphthalate glycol, acrylics, polyarylether ketones, polyethylene, polypropylene, polyaramides, polyesters, and polyarylamides.
